(19) United States
(12) Patent Application Publication
(10) Pub. No.: US 2024/0320505 A1
(43) Pub. Date: Sep. 26, 2024

(54) MODEL-BASED REINFORCEMENT LEARNING

(71) Applicant: Ford Global Technologies, LLC, Dearborn, MI (US)

(72) Inventors: Kaushik Balakrishnan, Mountain View, CA (US); Neeloy Chakraborty, Brentwood, TN (US); Devesh Upadhyay, Canton, MI (US)

(73) Assignee: Ford Global Technologies, LLC, Dearborn, MI (US)

(21) Appl. No.: 18/188,024

(22) Filed: Mar. 22, 2023

(51) Int. Cl. G06N 3/092

(52) U.S. Cl. CPC G06N 3/092

(57) ABSTRACT

A computer that includes a processor and a memory, the memory including instructions executable by the processor to train an agent neural network to input a first state and output a first action, input the first action to an environment and determine a second state and a reward. Koopman model neural network can be trained based on the first state, the first action and the second state to determine a fake state. The agent neural network can be re-trained and the Koopman model neural network can be re-trained based on reinforcement learning including the first state, the first action, the second state, the fake state, and the reward.

### BACKGROUND

Computers can be used to operate systems including vehicles, robots, drones, and/or object tracking systems. Data including images can be acquired by sensors and processed using a computer to determine a location of a system with respect to objects in an environment around the system. The computer can use the location data to determine trajectories for moving a system in the environment. The computer can then determine control data to transmit to system components to control system components to move the system according to the determined trajectories.

### BRIEF DESCRIPTION OF THE DRAWINGS

FIG. 1 is a block diagram of an example vehicle sensing system.

FIG. 2 is a diagram of an example agent neural network.

FIG. 3 is a diagram of an example Koopman-based reinforcement learning system.

FIG. 4 is a diagram of an example Koopman model.

FIG. 5 is a flowchart diagram of an example process to train a Koopman-based reinforcement learning system.

FIG. 6 is a flowchart diagram of an example process to control a vehicle with an agent neural network.

### DETAILED DESCRIPTION

A Koopman model provides a non-linear transformation of a system state to a new state where the dynamics are linear. A Koopman-based reinforcement learning system as described herein can be trained to operate a system based on the location of the system with respect to objects located in an environment around the system. Typically, sensor data can be provided to a computer to determine a location for the system and determine a system trajectory based on the location. A trajectory is a set of locations that can be indicated as coordinates in a coordinate system, along with velocities, e.g., vectors indicating speeds and headings, at respective locations. For example, a computer in a robot can determine the location of a gripper attached to a robotic arm and the location of an object on a conveyer belt. A trajectory can be determined that will move the robotic arm to a permit the gripper to pick up the object. A computer included in a vehicle, or a drone can determine the location of the vehicle or drone and determine a trajectory that can be followed to move the vehicle or drone to a selected location. A vehicle is described herein as a non-limiting example of a system that includes a computer to process sensor data and controllers to operate the vehicle based on output from the computer. Other systems that can include sensors, computers and controllers that can respond to objects in an environment around the system include robots, security systems and object tracking systems.

Techniques described herein use a Koopman-based reinforcement learning-based control system to determine optimal control policies for controlling vehicle propulsion, steering, and brakes to operate a vehicle. Assuming that a computer in a vehicle has determined a trajectory upon which to operate the vehicle, an optimal control policy can determine data to transmit to vehicle propulsion, steering, and brake controllers to cause the vehicle to operate along the determined trajectory. Control policies typically receive as input “states” which describe vehicle location and velocity, and output “actions” which describe commands to be transmitted to vehicle controllers. A control policy is considered optimal when it minimizes the time and energy required to accurately operate the vehicle along the trajectory within minimum and maximum constraints on lateral and longitudinal accelerations.

Techniques exist for determining optimal control policies. Rule-based systems rely on users to generate a potentially large number of heuristic rules, typically expressed in “if . . . then” formats that attempt to cover all of the potential states that can be input to the system. Rule-based systems may have difficulty anticipating all of the possible input states with sufficient resolution which could result in sub-optimal vehicle behavior, e.g., inaccurate, slow, and/or inefficient control. Machine learning techniques which typically use neural networks may improve upon rule-based systems but are dependent upon the techniques used to train the neural network.

For example, imitation learning trains the machine learning system based on acquiring data from human drivers. In this example, the performance of the machine learning system will be dependent upon the quality of the training data, because human drivers do not necessarily operate vehicles in uniformly optimal fashion for all driving conditions. Game theory-based systems model a control concern as a decision problem, where there are multiple decision makers, e.g., vehicles and pedestrians. Game theory-based systems assume that the players or decision makers make rational decisions and seeks an equilibrium solution for all players. In real world situations the vehicles/pedestrians/players can be unpredictable, which leads to non-optimal results. Model-free reinforcement learning can produce robust neural network control systems but can require many millions of data points to train a neural network-based controller. The system learns based on results which are used to determine reward functions that are fed back to the neural network for training. Results can be determined by outputting actions from the neural network control system to an environment, where the actions are implemented to generate a new state, e.g., a result. During training a neural network control system can produce both good and bad results, where the good results determine a positive reward and the bad results determine a negative reward which can lead to the system learning by making bad decisions, for example. Bad decisions can be non-optimal behavior for vehicles in traffic, which can be very undesirable. Techniques described herein use model-based reinforcement learning to reduce the amount of data required to train the system while providing accurate, timely and energy efficient control data for operating a vehicle without producing bad results.

Techniques described herein use a Koopman operator to model vehicle behavior. Vehicle behavior is typically based on a non-linear dynamic system. For example, vehicle trajectories for vehicle movements indicated by parking a vehicle typically include a plurality of linear segments that include vehicle stopping and changing direction. Koopman operators, as mentioned above, model non-linear vehicle behavior with a linear operator that is included in a neural network. The use of Koopman operators for linear determination of non-linear dynamics is described in: “Deep Learning for Universal Linear Embeddings of Nonlinear Dynamics,” by B. Lusch, J. N. Kutz and S. L. Brunton, Nature Communications 9, 4950, 2018. The neural network that includes the Koopman operator can be trained to model complex, non-linear vehicle behavior using reinforcement learning. Techniques as described herein can enhance determining control data for operating a vehicle by training a neural network that includes a Koopman operator. Also described herein are techniques that use the Koopman operator neural network to generate additional training data for training a neural network to determine control data for operating a vehicle.

A method is disclosed herein, including training an agent neural network to input a first state and output a first action, input the first action to an environment and determine a second state and a reward. A Koopman model neural network can be trained based on the first state, the first action and the second state to determine a fake state and re-training the agent neural network and re-training the Koopman model neural network based on reinforcement learning including the first state, the first action, the second state, the fake state, and the reward. The first state, the first action, the second state and the fake state can be input to a discriminator to train the Koopman model neural network. A discriminator loss function can be determined based on output from the discriminator. A Koopman loss function can be determined based on real transitions and fake transitions.

The Koopman model neural network can be trained based on combining the discriminator loss function with the Koopman loss function. The agent neural network can be re-trained based on a key performance indicator, wherein the key performance indicator evaluates the second state based on pre-determined criteria. The Koopman model neural network can include linear dynamics in a latent state to approximate a non-linear dynamic system. The reward can be determined based on a reward function that is based on the first state, the first action, and the second state. The reward can be determined by a second neural network. The agent neural network can be trained to operate a vehicle. The Koopman model neural network can determine optimal control policies for controlling vehicle propulsion, steering, and brakes to operate the vehicle. The reward can be based on how close the second state positions the vehicle with respect to a goal. The reinforcement learning can be modeled as a Markov decision process. The reinforcement learning can maximize a cumulative reward function.

Further disclosed is a computer readable medium, storing program instructions for executing some or all of the above method steps. Further disclosed is a computer programmed for executing some or all of the above method steps, including a computer apparatus, programmed to train an agent neural network to input a first state and output a first action, input the first action to an environment and determine a second state and a reward. A Koopman model neural network can be trained based on the first state, the first action and the second state to determine a fake state and re-training the agent neural network and re-training the Koopman model neural network based on reinforcement learning including the first state, the first action, the second state, the fake state, and the reward. The first state, the first action, the second state and the fake state can be input to a discriminator to train the Koopman model neural network. A discriminator loss function can be determined based on output from the discriminator. A Koopman loss function can be determined based on real transitions and fake transitions.

The instructions can include further instruction to train the Koopman model neural network based on combining the discriminator loss function with the Koopman loss function. The agent neural network can be re-trained based on a key performance indicator, wherein the key performance indicator evaluates the second state based on pre-determined criteria. The Koopman model neural network can include linear dynamics in a latent state to approximate a non-linear dynamic system. The reward can be determined based on a reward function that is based on the first state, the first action, and the second state. The reward can be determined by a second neural network. The agent neural network can be trained to operate a vehicle. The Koopman model neural network can determine optimal control policies for controlling vehicle propulsion, steering, and brakes to operate the vehicle. The reward can be based on how close the second state positions the vehicle with respect to a goal. The reinforcement learning can be modeled as a Markov decision process. The reinforcement learning can maximize a cumulative reward function.

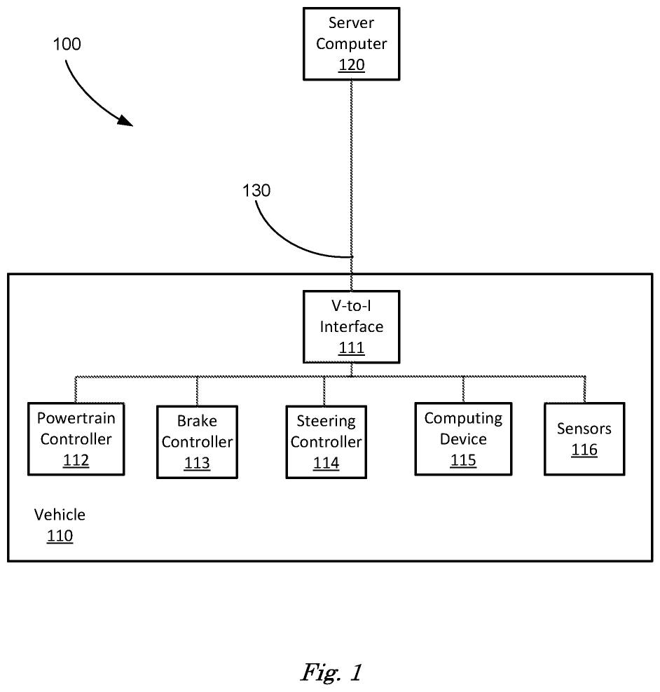

FIG. 1 is a diagram of a sensing system 100 that can include a server computer 120. Sensing system 100 includes a vehicle 110, operable in autonomous (“autonomous” by itself in this disclosure means “fully autonomous”), semi-autonomous, and/or occupant piloted (also referred to as non-autonomous) modes, as discussed in more detail below. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in autonomous, semi-autonomous, or manual modes, as stated above. By a semi- or fully-autonomous mode, we mean a mode of operation wherein a vehicle can be piloted partly or entirely by a computing device as part of a system having sensors and controllers. For purposes of this disclosure, an autonomous mode is defined as one in which each of vehicle propulsion (i.e., via a propulsion including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer. In a semi-autonomous mode, some but not all of them are controlled by a computer.

Server computer 120 typically has features in common, i.e., a computer processor and memory and configuration for communication via a network 130, with the vehicle 110 V2X interface 111 and computing device 115, and therefore these features will not be described further to avoid redundancy. A server computer 120 can be used to develop and train software that can be transmitted to a computing device 115 in a vehicle 110.

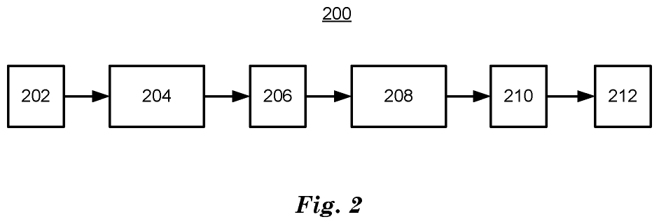

FIG. 2 is a diagram of a neural network system 200. Network system 200 can be developed and trained on a server computer 120 and transmitted to a computing device 115 included in a vehicle 110. Neural network system 200 can input a state sₜ 202 to an agent neural network 204, which outputs actions aₜ 206 regarding vehicle 110 behavior. For example, a computing device 115 in a vehicle 110 can acquire data from sensors 116 included in the vehicle to determine a state sₜ that indicates the location, orientation, and velocity of a vehicle 110 and the vehicles position with respect to objects in the environment around the vehicle 110. The agent neural network 204 can input the state sₜ 202 and output an action aₜ 206 that describes a predicted operation of a vehicle 110 in state sₜ 202. The action aₜ 206 can be output to an environment 208 which includes the vehicle 110. Performing action aₜ 206 in an environment 208 generates a second state sₜ₊₁ 210.

A reward rₜ 212 is also determined based on a reward function Rₐ(sₜ, sₜ₊₁) that takes as inputs a first state sₜ 202, and action aₜ 206, and a second state sₜ₊₁ 210 and determines a reward rₜ 212. In certain vehicle control concerns, the reward function Rₐ(sₜ, sₜ₊₁) is known, and a simple algebraic expression can be used to construct this reward function. For example, if the vehicle control concern is for operating a vehicle 110 on a highway, the reward function Rₐ(sₜ, sₜ₊₁) will provide high rewards if the vehicle speed is equal to a maximum speed determined based on speed limits, lateral and longitudinal accelerations are within bounds, and minimum distances between vehicles is observed. Other reward functions can be used, for example reward functions that yields the shortest travel time.

Another example could be for automatic parking, and for this the reward function Rₐ(sₜ, sₜ₊₁) can be based on how close the second state sₜ₊₁ 210 positions the vehicle 110 to an end goal. For example, a vehicle 110 can be located near a parking spot parallel to the parking spot with zero velocity. The location of the vehicle 110 with respect to a parking spot can be first state sₜ 202 to be input to agent neural network 204 to determine an action aₜ 206. Vehicle action aₜ 206 can be output to an environment 208, e.g., the vehicle 110 can be operated to attempt to park the vehicle 110. The result of performing action aₜ 206 in environment 208 can result in a second state sₜ₊₁ 210, e.g., the vehicle 110 is parked in the parking spot. In examples where a simple algebraic expression to determine a reward function cannot be constructed, a second neural network can be trained on the state s 202, action aₜ 206, and second state sₜ₊₁ 210 data to learn a reward function Rₐ(sₜ, sₜ₊₁).

Agent neural network 204 can be trained using reinforcement learning. Reinforcement learning can be modeled as a Markov decision process based on a probability Pₐ(sₜ, sₜ₊₁) that is the probability of transitioning from state a first state sₜ 202 to a second state sₜ₊₁ 210 based on an action aₜ 206. Reinforcement learning can train an agent neural network 204 by defining a reward function Ru(sₜ, sₜ₊₁) based on transitioning from a first state sₜ 202 to a second state sₜ₊₁ 210 based on an action aₜ 206. Reinforcement learning trains an agent neural network 204 by maximizing the cumulative reward function over a plurality of state transitions. Reinforcement learning can be model-free, where an agent neural network 204 is trained based on experience with an environment 208, where the reward function provides feedback to the agent neural network 204 to learn good control decisions for every state experienced during training.

Model-free reinforcement training can be an effective training technique for neural networks 204, however, for a complex problem such as certain automotive control applications, the number of states can be very diverse and large, and this makes the training of an agent data less efficient, often requiring several millions to tens of millions of transitions, or more. Model-based reinforcement training as described herein advantageously can reduce the time and computational resources required to train an agent neural network 204 over model-free reinforcement training. Model-based reinforcement training learns the system dynamics of a neural network system 200 using a model trained on real-world experience of an agent neural network 204. A model-based reinforcement training system uses the learned model to generate additional system transitions, where system transitions are a first state sₜ 202 to a second state sₜ₊₁ 210 based on an action aₜ 206 as discussed above. An agent neural network 204 can be trained using both real-world transitions and transitions generated by the model, which increases the number of training transitions while reducing the number of real-world transitions required.

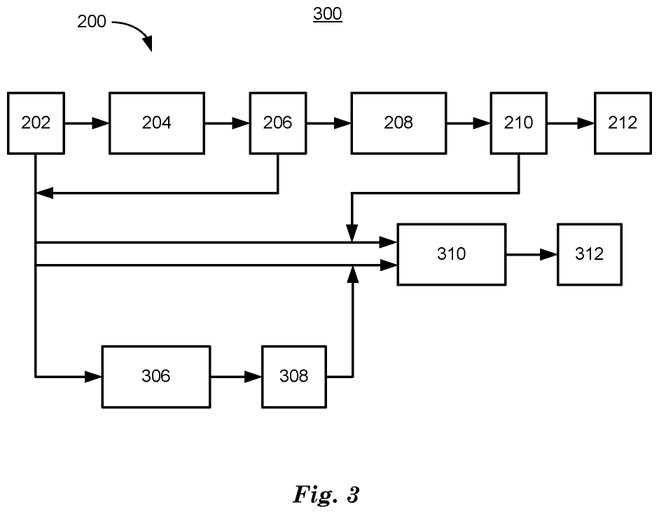

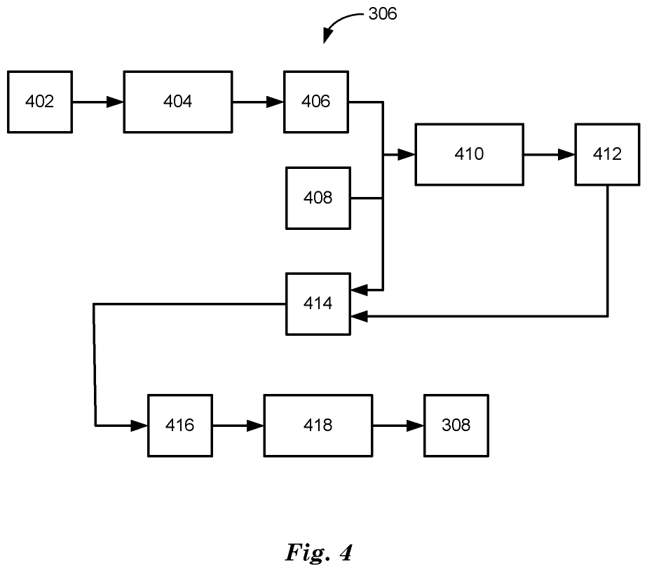

FIG. 3 is a diagram of a model-based reinforcement learning system 300. Model-based reinforcement learning system 300 can be used to train a Koopman model neural network 306 to generate additional state transitions (sₜ→aₜ→sₜ₊₁) that can be used to train agent neural network 204. Model-based reinforcement learning system 300 includes a trained agent neural network 204, that receives a first state sₜ 202 and outputs an action aₜ 206 as described above in relation to FIG. 2. Action aₜ 206 is output to an environment 208 is used to update the state to a second state sₜ₊₁ 210 based on an action aₜ 206. Model-based reinforcement learning system 300 includes a Koopman model neural network 306 that outputs a fake predicted state sₜ₊₁^{fake} 308. Koopman model neural network 306 is discussed in relation to FIG. 4, below.

Model-based reinforcement learning system 300 includes a generative adversarial network (GAN) discriminator 310. GAN discriminator 310 is trained to distinguish between real state transitions and fake state transitions based on inputting real state transition including first states sₜ 202, actions aₜ 206, and second states sₜ₊₁ 210 from neural network system 200. When the GAN discriminator 310 is trained to determine real state transitions from fake state can be used to train the Koopman model neural network 306 to output fake predicted states sₜ₊₁^{fake} 308 that are indistinguishable from real second states sₜ₊₁ 210 from neural network system 200.

The Koopman model neural network 306 is trained to minimize an error |sₜ₊₁^{fake}−sₜ₊₁|, e.g., to minimize the error between the fake predicted state and the actual future state. The Koopman model neural network 306 has an additional adversarial loss, which is based on fooling the GAN discriminator 310. Specifically, we consider (sₜ, aₜ, sₜ₊₁) as a “real” transition and (sₜ, aₜ, sₜ₊₁^{fake}) as a “fake” transition. The GAN Discriminator is trained to differentiate between the real and fake, i.e., to output 312 a “1” for “real” input and “0” for a “fake” input.

The Koopman model neural network 306 has an additional loss term that tries to fool the GAN discriminator (i.e., the goal is to obtain output from the GAN discriminator that a fake input is real), which helps the Koopman model to produce fake transitions that are closer to the real ones. The Koopman model neural network 306 can be trained using a Wasserstein function with gradient penalty as the adversarial loss. This is an additional learning signal for the Koopman model neural network 306 which in this example is extended to reinforcement learning. The Koopman model neural network 306 and the GAN discriminator 310 are trained using two loss functions, a Koopman loss function L^{Koopman} and a discriminator loss function L^{Discriminator}:

$${L}^{Koopman} = \vert {s}_{t + 1}^{fake} - {s}_{t + 1} \vert + λ𝔼 [ D ( {s}_{t} , {a}_{t} , {s}_{t + 1}^{fake} ) ] \qquad ( 1 )$$

$${L}^{Discriminator} = 𝔼 [ D ( {s}_{t} , {a}_{t} , {s}_{t + 1}^{fake} ) ] - 𝔼 [ D ( {s}_{t} , {a}_{t} , {s}_{t + 1} ) ] \qquad ( 2 )$$

Where [symbol] is the expectation operator, D( ) is the GAN discriminator 310 and λ is an empirically determined constant that determines the ratio of prediction loss to GAN discriminator 310 to be used in training the Koopman model neural network 306. Techniques described herein enhance training of neural networks 204 to determine vehicle control policies by extending reinforcement learning to training control policies using Koopman model neural networks 306 and GAN discriminators 310.

FIG. 4. is a diagram of a Koopman model neural network 306. Koopman model neural network 306 includes three sub-neural networks, including an encoder neural network 404, an auxiliary neural network 410, and a decoder neural network 418. The first sub-neural network is an encoder neural network 404 that inputs a state sₜ 402 as input and outputs a multi-dimensional latent vector at time t, zₜ 406. An action aₜ 408 and the latent vector zₜ 406 are concatenated and fed as input to the auxiliary neural network 410. The auxillary neural network 410 outputs matrices 412, which include a Koopman matrix K, and an action matrix A. The latent state at the future time step t+1 is then evaluated by linear system dynamics 414 as K zₜ+A aₜ and output as zₜ₊₁ 416, where the Koopman matrix K is sized based on the dimensionality of the latent vector z 406. Note that the system dynamics are non-linear in the physical space s, but are linear in the embedding space z, as determined by Koopman theory. The function of a Koopman model is to project the data from the physical space s to the latent embedding space z, where the system dynamics are advanced from time t to t+1. Then, a decoder neural network 418 can be used to re-project the data from the latent embedding space to physical space, i.e., from zₜ₊₁ 416 to sₜ₊₁ 308. Note that the encoder neural network 404, the decoder neural network 418 and the auxiliary neural network 410 are jointly trained using neural network training techniques discussed above in relation to FIG. 3.

Following training of the Koopman model neural network 306 and the GAN discriminator 310, the agent neural network 204 and the Koopman model neural network 306 can be re-trained using the initial training dataset of transitions (sₜ, aₜ, sₜ₊₁) and the transitions generated by the Koopman model neural network (sₜ, aₜ^{fake}, sₜ₊₁^{fake}). Training the agent neural network 204 can include a reward function Rₐ(sₜ, s^{t+1}) as discussed above in relation to FIG. 2 that inputs a first state sₜ 202, an action aₜ 206, and a second state sₜ₊₁ 210 and outputs a reward rₜ 212. A fake reward rₜ^{fake} can be generated by reward function Rₐ(sₜ, sₜ₊₁^{fake}) based on fake transitions (sₜ, aₜ^{fake}, sₜ₊₁^{fake}) generated by a Koopman model neural network 306.

Training the agent neural network 204 and Koopman model neural network 306 is performed iteratively, until the second state sₜ₊₁ 210, also referred to herein as an agent policy, meets a key performance indicator (KPI). A key performance indicator is a quantifiable measurement or metric applied to a process used to gauge progress towards an intended goal. In examples described herein, the KPI will depend upon the agent policy output by the agent neural network and includes evaluating vehicle 110 operation according to pre-determined criteria for performance applied to the vehicle 110 as it operates in the environment 208. For example, KPI's include factors such as compliance with traffic laws, maintaining minimum distances between vehicles, maintaining minimum and maximum lateral and longitudinal accelerations, and amount of time required to perform the operation, etc. For examples that include operating robots and object tracking systems other KPI's can be determined that address robotic arm accuracy, object location accuracy, and system speed, etc.

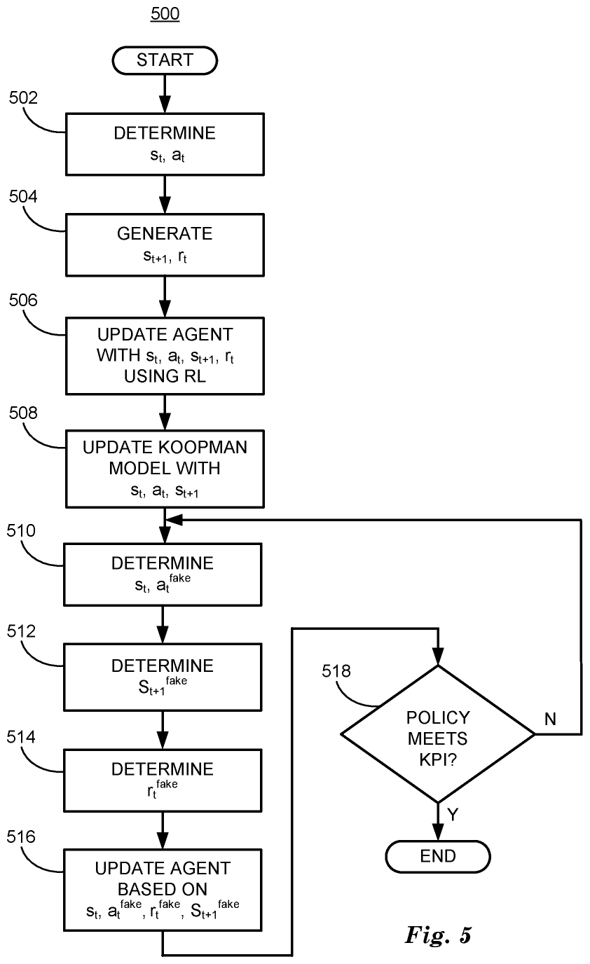

FIG. 5 is a flowchart, described in relation to FIGS. 1-4 of a process 500 for determining an agent neural network 204 and a Koopman model neural network 306. Process 500 can be implemented by a processor of a server computer 120, based on real transitions (sₜ, aₜ, sₜ₊₁) and fake transitions (sₜ, aₜ^{fake}, sₜ₊₁^{fake}) generated by a Koopman model neural network 306. Process 500 includes multiple blocks that can be executed in the illustrated order. Process 500 could alternatively or additionally include fewer blocks or can include the blocks executed in different orders.

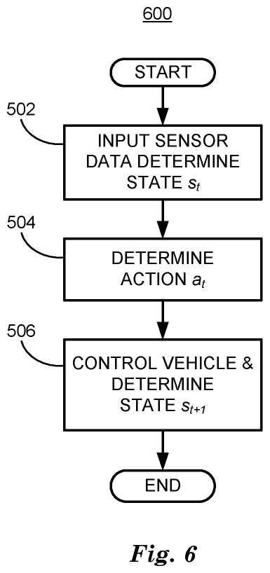

Process 500 begins at block 502 where a server computer 120 inputs a first state sₜ 202 into a trained agent neural network 204 and outputs an action aₜ 206 as described above in relation to FIG. 2 and FIG. 6, below.

At block 504, the action aₜ 206 is output to an environment 208 to generate a second state sₜ₊₁ and a reward rₜ as described above in relation to FIG. 2. The environment 208 can be an environment around a vehicle 110 and the second state sₜ₊₁ and the reward rₜ can be generated by operating a vehicle 110 according to the action aₜ 206. For example, the action aₜ 206 can include instructions to park the vehicle 110 in a parking spot.

At block 506, the agent neural network 204 is updated by retraining the agent neural network 204 using reinforcement learning based on the first state sₜ 202, the action aₜ 206, the second state sₜ₊₁ and the reward rₜ as discussed in relation to FIGS. 3 and 4, above.

At block 508 a Koopman model neural network 306 is updated by retraining the Koopman model neural network 306 based on the first state sₜ 202, the action aₜ 206, and the second state sₜ₊₁ as discussed above in relation to FIGS. 3 and 4, above.

At block 510 the Koopman model neural network 306 is used to determine a fake action aₜ^{fake} in response to an input first state sₜ 202 as discussed above in relation to FIG. 4, above.

At block 512 a fake second state sₜ₊₁^{fake} 308 is generated by a Koopman model neural network 306 inputting a first state sₜ 202 as discussed in relation to FIG. 4, above.

At block 514 a fake reward rₜ^{fake} is determined based on fake transitions (sₜ, aₜ^{fake}, sₜ₊₁^{fake}) based on a reward function Rₐ(sₜ, sₜ₊₁) as discussed in relation to FIG. 4, above.

At block 516 the agent neural network 204 is updated by retraining the agent neural network 204 based on fake transitions (sₜ, aₜ^{fake}, sₜ₊₁^{fake}) and the fake reward rₜ^{fake}.

At block 518 the transition (sₜ, aₜ, sₜ₊₁) output by the agent neural network 204 and the environment 208 is tested against a selected KPI. The KPI compares the operation of the vehicle 110 against selected performance indicators such as compliance with traffic rules, distance between vehicles and upper and lower limits on lateral and longitudinal accelerations. If the transition (sₜ, aₜ, sₜ₊₁) does not meet the selected KPI, process 500 returns to block 510 to determine a new fake transition (sₜ, aₜ^{fake}, sₜ₊₁^{fake}) and the fake reward rₜ^{fake} to re-train agent neural network 204. If the transition (sₜ, aₜ, sₜ₊₁) does meet the selected KPI, following block 518 process 500 ends.

FIG. 6 is a flowchart, described in relation to FIGS. 1-5 of a process 600 for controlling a vehicle 110 using an agent neural network 204 trained using a Koopman model neural network 306. Process 600 can be implemented by computing device 115 included in a vehicle 110, based on trained agent neural network 204 transmitted to the computing device 115 from a server computer 120 upon which the agent neural network 204 was trained. Process 600 includes multiple blocks that can be executed in the illustrated order. Process 600 could alternatively or additionally include fewer blocks or can include the blocks executed in different orders.

Process 600 begins at block 602 where a computing device 115 in a vehicle 110 determines a current vehicle state sₜ by inputting data from vehicle sensors 116. Computing device 115 determines a vehicle state s^{t} at time t by determining vehicle state variables such as vehicle location, orientation, and velocity, and data regarding moving and non-moving objects in an environment around a vehicle 110 such as other vehicles and roadway markings. Computing device 115 can also access map data which can provide data regarding traffic regulations and routes, etc. Computing device 115 inputs vehicle sensor and environmental data and assembles the vehicle data into a format for input to agent neural network 504.

At block 604 an agent neural network 204 included in computing device 115 inputs vehicle state sₜ. Agent neural network 204 has been trained with a Koopman model neural network 306 using model-based reinforcement learning as described above in relation to FIGS. 3 and 4 to input a vehicle state sₜ and output an action aₜ. For example, action aₜ can be high-level instruction for operating a vehicle 110. Examples of actions aₜ include vehicle instructions such as “STOP”, “ACCELERATE”, and “TURN LEFT”, etc. In some examples, action aₜ can be a vehicle trajectory which can be output by agent neural network 504.

At block 606 computing device 115 inputs the vehicle action aₜ and, if necessary, first converts actions aₜ to a vehicle trajectory. A vehicle trajectory can be a polynomial function that predicts vehicle locations and velocities. Computing device 115 can determine the vehicle trajectory by determining a polynomial function that will connect a current vehicle location with a goal location without causing the vehicle to exceed minimum and maximum limits on lateral and longitudinal acceleration. Computing device 115 can issue commands output to controllers 112, 113, 114 to control vehicle propulsion, steering, and brakes to operate vehicle 110 along the determined trajectory in the environment 208. By operating vehicle 110 in the environment 208, computing device 115 generates a new state sₜ₊₁ for vehicle 110 by changing the location, orientation, velocity, and the relationship of vehicle 110 to objects in the environment. The new location, orientation, and velocity of the vehicle and the new relationship between vehicle 110 and object in the environment is captured by vehicle sensors 116 to generate a new vehicle state sₜ₊₁ to be input to agent neural network 204 to determine a new vehicle action aₜ₊₁. Following block 606 process 600 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
train an agent neural network to input a first state and output a first action, input the first action to an environment and determine a second state and a reward;
train a Koopman model neural network based on the first state, the first action and the second state to determine a fake state; and
re-train the agent neural network and re-training the Koopman model neural network based on reinforcement learning including the first state, the first action, the second state, the fake state, and the reward.

2. The system of claim 1, wherein the first state, the first action, the second state and the fake state are input to a discriminator to train the Koopman model neural network.

3. The system of claim 2, wherein a discriminator loss function is determined based on output from the discriminator.

4. The system of claim 3, wherein a Koopman loss function is determined based on real transitions and fake transitions.

5. The system of claim 4, wherein the Koopman model neural network is trained based on combining the discriminator loss function with the Koopman loss function.

6. The system of claim 1, wherein the agent neural network is re-trained based on a key performance indicator, wherein the key performance indicator evaluates the second state based on pre-determined criteria.

7. The system of claim 1, wherein the Koopman model neural network includes linear dynamics in a latent state to approximate a non-linear dynamic system.

8. The system of claim 1, wherein the reward is determined based on a reward function that is based on the first state, the first action, and the second state.

9. The system of claim 1, wherein the reward is determined by a second neural network.

10. The system of claim 1, wherein the agent neural network is trained to operate a vehicle.

11. A method, comprising:
training an agent neural network to input a first state and output a first action, input the first action to an environment and determine a second state and a reward;
training a Koopman model neural network based on the first state, the first action and the second state to determine a fake state; and
re-training the agent neural network and re-training the Koopman model neural network based on reinforcement learning including the first state, the first action, the second state, the fake state, and the reward.

12. The method of claim 11, wherein the first state, the first action, the second state and the fake state are input to a discriminator to train the Koopman model neural network.

13. The method of claim 12, wherein a discriminator loss function is determined based on output from the discriminator.

14. The method of claim 13, wherein a Koopman loss function is determined based on real transitions and fake transitions.

15. The method of claim 14, wherein the Koopman model neural network is trained based on combining the discriminator loss function with the Koopman loss function.

16. The method of claim 11, wherein the agent neural network is re-trained based on a key performance indicator, wherein the key performance indicator evaluates the second state based on pre-determined criteria.

17. The method of claim 11, wherein the Koopman model neural network includes linear dynamics in a latent state to approximate a non-linear dynamic system.

18. The method of claim 11, wherein the reward is determined based on a reward function that is based on the first state, the first action, and the second state.

19. The method of claim 11, wherein the reward is determined by a second neural network.

20. The method of claim 11, wherein the agent neural network is trained to operate a vehicle.
